(19) United States
(12) Patent Application Publication
(10) Pub. No.: US 2012/0071008 A1
(43) Pub. Date: Mar. 22, 2012

(54) MAGNETIC ELECTRICAL COUPLING ADAPTOR

(76) Inventor: KARUS DAVID SESSFORD, Lethbridge (CA)

(21) Appl. No.: 12/886,481

(22) Filed: Sep. 20, 2010

(51) Int. Cl. H01R 13/60

(52) U.S. Cl. 439/39

(57) ABSTRACT

A magnetic electrical coupling adapter to identify the positive coupling prior to activating an electrical circuit is disclosed. The adapter comprises at least one controlling connector, at least one receiving connector and a plurality of magnets. The magnets provide strong attractive force between the connectors for maintaining positive coupling between the connectors. The controlling connector includes a plurality of male prongs, at least one mating face having a plurality of contact points and at least one regulating circuitry. The regulating circuitry controls the electricity between the male prongs. The receiving connector comprises a plurality of female prongs, at least one mating face having a plurality of contact points and at least one identification circuitry. The identification circuitry provides digital signature to the regulating circuitry when the connectors are positively coupled. Thus the regulating circuitry and the identification circuitry negate the possibility of electrical shock to a user.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to a magnetic electrical coupling adaptor and more particularly to an exposure-controlled magnetic electrical coupling adaptor to positively identify the coupling prior to energizing the contacts.

Electrical devices are connected to an electrical source by means of a male plug inserted into a female receptacle. The contacts are maintained through the force of friction that the female receptacle asserts on the male prongs and can vary depending on the condition of the prongs. Use of a standard plug in inclement environments, such as in snowy, muddy, or dusty conditions can cause debris to be forced into the female receptacle, jamming it up and causing the receptacle to be inoperable, as well as being potentially unsafe for the operator. Magnetic coupling has been used to somewhat overcome the variation in coupling forces; however, it has not adequately addressed operator safety, often leaving the energized contacts exposed to the user.

Various magnetic coupling devices have been developed to overcome the variation of coupling forces. The electromechanical connector proposed has a switch and an actuator. The switch can be connected by means of contacts to a power supply and has switching magnets with encoded magnetic elements mounted on a carriage. It is fitted in a housing as an enclosed unit. The actuator has actuation magnets with encoded magnetic elements and can be connected to a consumer. The switch can be connected to the actuator, connecting these two devices causing the switching magnets to move, against a restraining force, from an inoperative position to an operating position. The electrical connection between the switch and the actuator is thus established by means of contacts. The ends of the switch and actuator facing each other are fitted with alignment devices designed so that electrical contact between the switch and the actuator can only be made when the contacts are in a particular position with respect to each other. An example of such devices includes U.S. Pat. No. 4,451,113, issued to Zuniga on May 29, 1984, which discloses a magnetically-actuated safety receptacle and plug characterized by a receptacle having a pair of electrical contacts extending through a support member with an over-center drop-out member hinged to the support member with a second pair of electrical contacts. When a magnetic plug is inserted into a recess provided in the front of the support member the drop-out member is magnetically attracted towards the support member so that the first pair of electrical contacts and the second pair of electrical contacts abut to provide power to the plug. The hinge attaching the drop-out member to the support member is articulated so that the contacts can wipe against each other to remove any oxide build up. An industrial version of this invention includes a gas-tight enclosure surrounding the drop-out member and the interior contacts to prevent accidental ignition of combustible gases. This prior art patent mechanically limits the exposure of the user to energized contacts. However, this magnetic plug is complicated to use and fails to safeguard against the hazard of accidental activation that can be caused by nearby magnetic fields.

U.S. Pat. No. 6,966,781 issued to Ballinger on Nov. 22, 2005 discloses an electromechanical connector that has a switch and an actuator. The switch can be connected by means of contacts to a power supply and has switching magnets with encoded magnetic elements mounted on a carriage. It is fitted in a housing as an enclosed unit. The actuator has actuation magnets with encoded magnetic elements and can be connected to a consumer. The switch can be connected to the actuator, connecting these two devices causing the switching magnets to move, against a restraining force, from an inoperative position to an operating position. The electrical connection between the switch and the actuator is thus established by means of contacts. The ends of the switch and actuator facing each other are fitted with alignment devices designed so that electrical contact between the switch and the actuator can only be made when the contacts are in a particular position with respect to each other. Even though these devices are mechanically prevented from energizing prior to positive coupling, they are complicated in implementation, and are not an adaptor type.

U.S. Pat. No. 7,726,973 to Perry on Jun. 1, 2010 discloses a power cord assembly with an electrical outlet socket adapted to electrically couple to the existing power source. The electrical outlet socket may have a first group of electro-conductive plates, statically affixed to its outer surface. A power cord is also provided, which remains physically spaced from the electrical outlet socket. An adaptor may be removably coupled directly to the power cord. Such an adaptor preferably has a second group of electro-conductive plates statically affixed to its outer surface. The present invention also includes a mechanism for continuously transmitting an electric current from the electrical outlet socket through the adaptor and to the power cord while the first and second groups of electro-conductive plates are abutted against each other. The adaptor remains intermediately positioned between the electrical outlet socket and the power cord during continuous transmission of the electric current to the power cord. The above disclosed device describes a magnetic mating system, but would not be useful in inclement environments due to the possibility of debris getting caught in the receptacle.

It is therefore, an object of the present invention to provide a device that uses a digital electronic signature to positively identify the positive coupling prior to energizing the contacts. Thus, the user is fully protected against possible electrical shock when the device is uncoupled and the contacts are thus exposed. This change represents a significant improvement to the safety of the device. Furthermore, this device is usable as an adaptor between a standard plug and a standard receptacle, thereby allowing retrofit use for all types of common household and business devices in any type of environment, even outdoors at any time of the year. Moreover, the device can also be used with common household voltages as well as the lowest voltages, and can be used in AC or DC situations to transmit electrical signals. Other objects of the present invention will become better understood with reference to the appended Summary, Description and Claims.

### SUMMARY

The present invention is a magnetic electrical coupling adapter to identify the positive coupling prior to activating an electrical circuit. The magnetic electrical coupling adapter comprises at least one controlling connector, at least one receiving connector and a plurality of magnets placed in the controlling connector and the receiving connector. The controlling connector includes a plurality of male prongs extruding from the controlling connector, at least one mating face having a plurality of contact points at a rear portion of the controlling connector; and at least one regulating circuitry imbedded in the controlling connector for controlling the electricity between the plurality of male prongs. The receiving connector comprises a plurality of female prongs imbedded in the receiving connector, a mating face having a plurality of contact points at a front portion of the receiving connector, and at least one identification circuitry imbedded in the receiving connector.

The mating face of the controlling connector and the mating face of the receiving connector are complementary to each other and the plurality of contact points, of each of the mating faces contact each other, when the mating face of the controlling connector and the mating face of the receiving connector are connected. The plurality of magnets placed in the controlling connector and the receiving connector provides a strong attractive force between the controlling connector and the receiving connector for maintaining a positive coupling between the controlling connector and the receiving connector. The regulating circuitry imbedded in the controlling connector controls the electricity between the plurality of male prongs and the plurality of contact points in the controlling connector. When the plurality of contact points in the controlling connector and the receiving connector are positively connected, the identification circuitry imbedded in the receiving connector provides a digital signature to the regulating circuitry allowing full voltage and amperage from the receiving connector to flow to the controlling connector.

A plurality of wires in the controlling connector connects the plurality of male prongs to the regulating circuitry and on to the plurality of contact points in the controlling connector and a plurality of wires in the receiving connector connects the plurality of contact points in the receiving connector to the identification circuitry and on to the plurality of female prongs. Thus, the positive mating of the mating face of the controlling connector and the mating face of the receiving connector connects the plurality of contact points in the controlling connector and the plurality of contact points in the receiving connector allowing the regulating circuitry to recognize a positive coupling by means of the identification circuitry. The positive coupling between the controlling connector and the receiving connector allows the electricity from the plurality of male prongs to travel through the plurality of contact points in the controlling connector, and on to the plurality of female prong receptacles.

The mating face of the controlling connector and the receiving connector includes a plurality of edges and the plurality of edges of each of the connectors includes an exterior insulating gasket. The plurality of edges further includes at least one grounding contact to provide a grounding circuit to the magnetic electrical coupling adapter. The mating face of each of the connectors may be arranged in wave shape to reduce the possibility that debris could hinder the mating of the controlling connector and the receiving connector during normal use, as any debris could be easily wiped out.

Although particular embodiments of the present invention have been described in the foregoing description, it is to be understood that the present invention is not to be limited to just the embodiments disclosed, but that they are capable of numerous rearrangements, modifications and substitutions without departing from the description herein.

### BRIEF DESCRIPTION OF THE DRAWINGS

FIG. 1 is a front perspective view of a magnetic electrical coupling adapter in accordance with the present invention.

FIG. 2 is a rear perspective view of the magnetic electrical coupling adapter in accordance with the present invention.

FIG. 3 is a cross sectional view of at least one controlling connector and at least one receiving connector of the present invention.

FIG. 4 is an inner perspective view of the at least one controlling connector and at least one receiving connector of the present invention.

FIG. 5 is a front view of at least one mating face of the present invention.

### REFERENCE NUMERALS

10 . . . Magnetic electrical coupling adapter
12 . . . At least one controlling connector
14 . . . At least one receiving connector
16 . . . A plurality of male prongs
18 . . . At least one mating face of the controlling connector
20 . . . A plurality of contact points of the controlling connector
22 . . . Rear portion of the controlling connector
24 . . . A plurality of female prongs
26 . . . At least one mating face of the receiving connector
28 . . . A plurality of contact points of the receiving connector
30 . . . Front portion of the receiving connector
32 . . . At least one regulating circuitry
34 . . . At least one identification circuitry
36 . . . A plurality of magnets in the controlling connector
38 . . . A plurality of magnets in the receiving connector
40 . . . Exterior insulating gasket
42 . . . At least one grounding contact

### DETAILED DESCRIPTION

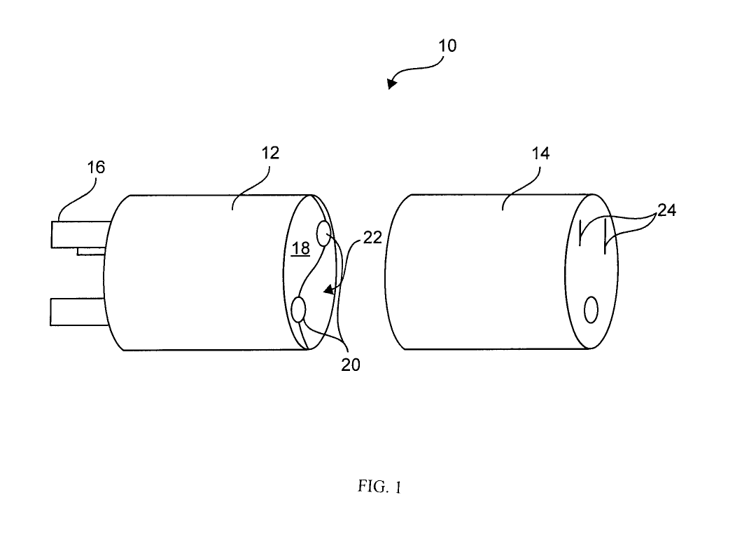

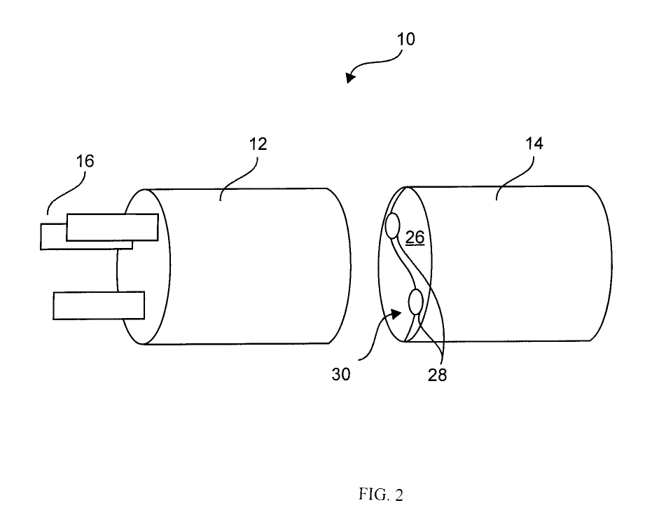

Referring to the drawings, a preferred embodiment of a magnetic electrical coupling adapter 10 to identify the positive coupling prior for activating an electrical circuit is illustrated and generally indicated as 10 in FIGS. 1-6. FIGS. 1 and 2 show perspective views of the magnetic electrical coupling adapter 10. The magnetic electrical coupling adapter 10 comprises at least one controlling connector 12, at least one receiving connector 14 and a plurality of magnets (not shown) placed in the controlling connector 12 and the receiving connector 14. The controlling connector 12 includes a plurality of male prongs 16 extruding from the controlling connector 12, at least one mating face 18 having a plurality of contact points 20 at a rear portion 22 of the controlling connector 12, and at least one regulating circuitry (not shown) imbedded in the controlling connector 12 for controlling the electricity between the plurality of male prongs 16. As shown in FIGS. 1 and 2, the receiving connector 14 comprises a plurality of female prongs 24 imbedded in the receiving connector 14, at least one mating face 26 having a plurality of contact points 28 at a front portion 30 of the receiving connector 14, and at least one identification circuitry (not shown) imbedded in the receiving connector 14.

The mating faces 18, 26 are complementary to each other and the plurality of contact points 20, 28 of each of the mating faces 18, 26 contact each other when the mating faces 18, 26 are connected.

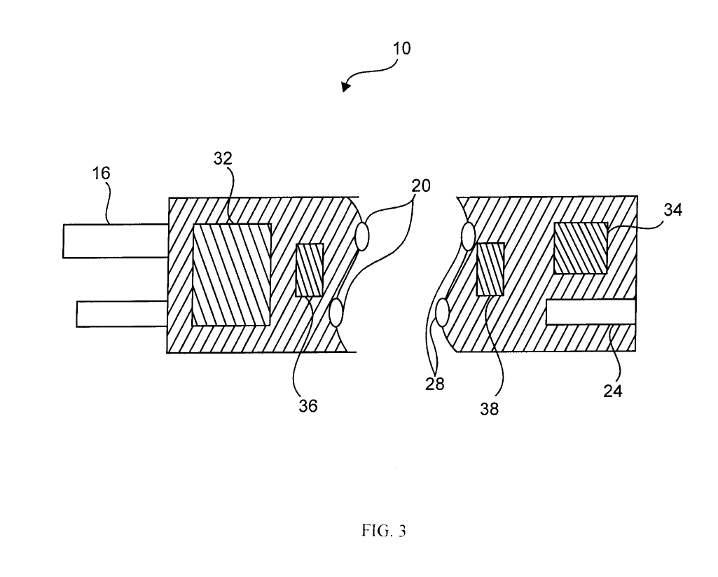

FIG. 3 shows a cross sectional view of the controlling connector 12 and the receiving connector 14 of the magnetic electrical coupling adapter 10. The regulating circuitry 32 imbedded in the controlling connector 12 controls the electricity between the plurality of male prongs 16 and the plurality of contact points 20 in the controlling connector 12. When the contact points 20, 28 are positively connected, the identification circuitry 34 provides a digital signature to the regulating circuitry 32 allowing full voltage and amperage from the receiving connector 14 to flow to the controlling connector 12.

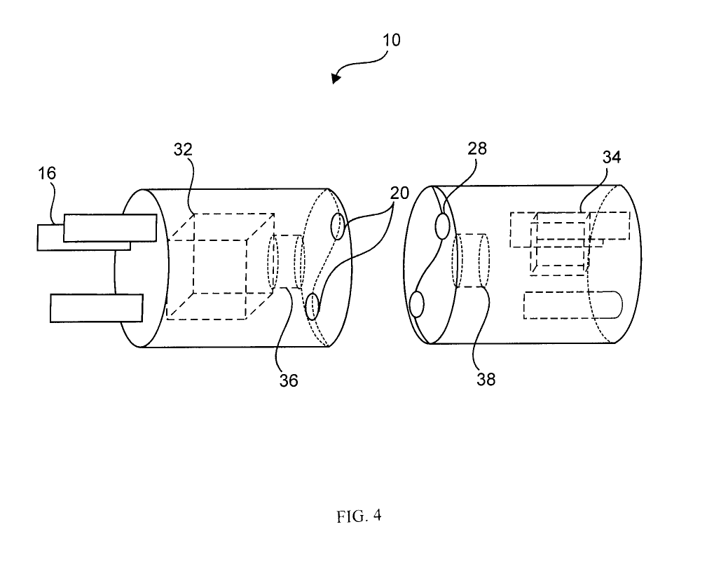

Each of the circuitry 32, 34 negates the possibility of electrical shock to a user by de-energizing the contact points 20, 28, when the mating faces 18, 26 are not positively coupled. The plurality of magnets 36, 38 placed in the controlling connector 12 and the receiving connector 14 provides strong attractive force between the controlling connector 12 and the receiving connector 14 for maintaining positive coupling between the controlling connector 12 and the receiving connector 14. FIG. 4 is an inner perspective view of the magnetic electrical coupling adapter 10. A plurality of wires (not shown) in the controlling connector 12 connects the plurality of male prongs 16 to the regulating circuitry 32 and on to the plurality of contact points 20 in the controlling connector 12 and a plurality of wires (not shown) in the receiving connector 14 connects the plurality of contact points 28 in the receiving connector 12 to the identification circuitry 34 and on to the plurality of female prongs 24. Thus, the positive mating of the mating faces 18, 26 connect the plurality of contact points 20, 28 allowing the regulating circuitry 32 to recognize positive coupling by means of the identification circuitry 34. The positive coupling between the controlling connector 12 and the receiving connector 14 allows the electricity from the plurality of male prongs 16 to travel through the plurality of contact points 20 in the controlling connector 12, and on to the plurality of female prongs 24. The plurality of magnets 36, 38 could be replaced by any number of electromagnets. If there were at least one magnet or electromagnet, only a ferromagnetic material would need to be provided on the opposite contact to maintain a connection. The plurality of magnets 36, 38 may be incorporated as a part of the plurality of contact points 20, 28 or may be located elsewhere on the adapter, provided that the magnets maintain an attractive force between each other.

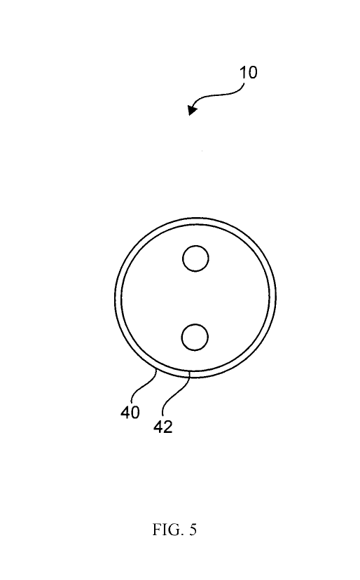

FIG. 5 is a front view of the at least one mating face 18 of the present invention. The at least one mating face 18 includes a plurality of edges (not shown) and the plurality of edges (not shown) includes an exterior insulating gasket 40. The plurality of edges (not shown) further includes at least one grounding contact 42 to provide a grounding circuit to the magnetic electrical coupling adapter 10. The mating faces 18, 26 may be arranged in wave shape to reduce the possibility that debris could hinder mating of the connectors during normal use, as any debris could be easily wiped out. The mating faces 18, 26 may be flat, or slightly rounded, in a number of wave or indent forms, such that positive mating between the contact points 20, 28 still occurs, and the mating face 18, 26 is relatively flat.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understood that the present invention has been described by way of illustration and not limitation

1. A golf swing practicing device for a user comprising:
at least one hard board having a plurality of holes adapted for surface mounting;
at least one hinge means having a first hinge, arm, a second hinge arm and a pivot arm, the at least one hinge means being connected in an articulated manner to the at least one hard board;
a plurality of wedges mounted to the at least one hard board;
at least one hanger bolt attached to the pivot arm of the at least one hinge means;
at least one extension spring having a proximal end and a distal end; and
at least one golf ball positioned at a top end of the at least one hanger bolt.

2. The device of claim 1, wherein the plurality of holes of the at least one hard board is adapted for receiving the at least one hinge means, the plurality of wedges and the at least one extension spring by a fastening means, including a screw, bolt and washer.

3. The device of claim 1, wherein the first hinge arm includes a plurality of holes.

4. The device of claim 1, wherein the second hinge arm is secured to the at least one hard board by the fastening means.

5. The device of claim 1, wherein the plurality of wedges is configured to receive the at least one hinge means.

6. The device of claim 1, wherein the at least one hanger bolt is attached to the pivot arm of the at least one hinge means by welding.

7. The device of claim 1, wherein the proximal end of the at least one extension spring is secured to the at least one of the plurality of holes of the first hinge arm.

8. The device of claim 1, wherein the distal end of the at least one extension spring is secured to the at least one hard board by the fastening means.

9. A golf swing practicing device for a user comprising:
at least one hard board having a plurality of holes adapted for surface mounting;
at least one hinge means having a first hinge arm, a second hinge arm and a pivot arm, the at least one hinge means being connected in an articulated manner to the at least one hard board;
a plurality of wedges mounted to the at least one hard board;
at least one hanger bolt attached to the pivot arm of the at least one hinge means;
at least one extension spring having a proximal end and a distal end;
at least one golf ball positioned at a top end of the at least one hanger bolt;
a plurality of supporting pads attached to opposing first and second ends of an inner surface of the first hinge arm;
a set of plurality of pads fixed to at least one end of the plurality of wedges proximate the at least one hinge means; and
a plurality of pads that functions as an artificial golf turf pad fixed to the at least one hard board;
whereby a carpet placed over the golf swing practicing device may render an appearance of a green grass.

10. The device of claim 9, wherein the plurality of holes of the at least one hard board is adapted for receiving the at least one hinge means, the plurality of wedges and the at least one extension spring by a fastening means, including a screw, bolt and washer.

11. The device of claim 9, wherein the first hinge arm includes a plurality of holes.

12. The device of claim 9, wherein the second hinge arm is secured to the at least one hard board by the fastening means.

13. The device of claim 9, wherein the plurality of wedges is configured to receive the at least one hinge means.

14. The device of claim 9, wherein the at least one hanger bolt is attached to the pivot arm of the at least one hinge means by welding.

15. The device of claim 9, wherein the proximal end of the at least one extension spring is secured to the at least one of the plurality of holes of the first hinge arm.

16. The device of claim 9, wherein the distal end of the at least one extension spring is secured to the at least one hard board by the fastening means.

17. The device of claim 9, wherein the carpet includes a hole adapted to receive the golf swing practicing device.

18. A method for practicing golf swing by a user, the method comprising the steps of:
a. providing a golf swing practicing device comprising at least one hard board, at least one hinge means, a plurality of wedges, at least one hanger bolt, at least one extension spring, at least one golf ball, a plurality of supporting pads, a set of plurality of pads and a plurality of pads;
b. placing a carpet over the golf swing practicing device;
c. standing on the at least one hard board;
d. putting the at least one golf ball by a golf club; and
e. awaiting for the at least one golf ball to return to the original position.

19. The method of claim 15, wherein the steps (d) and (e) may be repeated.

20. The method of claim 15, wherein the at least one extension spring facilitates returning the at least one golf ball to the original position.
